(19) United States
(12) Patent Application Publication
(10) Pub. No.: US 2004/0147216 A1
(43) Pub. Date: Jul. 29, 2004

(54) ENVIRONMENTAL PROTECTION BOOTH

(76) Inventors: Toni M Temple, Parma Hts., OH (US); Neal A. Pence, Urbana, OH (US); Erin Litzenberg, Lexington, KY (US); Sachi Hergesheimer, Essex Junction, VT (US); Ryan Hollinger, Little Rock, AR (US)

Correspondence Address: GREENBERG & LIEBERMAN, 314 PHILADELPHIA AVE., TAKOMA PARK, MD, 20912, US

(21) Appl. No.: 10/707,040

(22) Filed: Nov. 17, 2003

Related U.S. Application Data
(60) Provisional application No. 60/319,700, filed on Nov. 15, 2002.

(51) Int. Cl. B01L 1/04

(52) U.S. Cl. 454/187

(57) ABSTRACT

A booth with a plurality of sides, a base, a top, and an air filter system, formed from materials that do not emit environmental irritants. The booth may be used in a wide range of places, such as offices, theaters, homes, concerts and sports arenas.

### BACKGROUND OF INVENTION

This present invention generally relates to health protective enclosures. More particularly, the present invention provides apparatuses and methods for preventing multiple chemical sensitive, disabled or infected individuals from exposures to environmental irritants, and from further illness.

Existing clean air enclosures rid air irritants but do not resolve the problems facing individuals with multiple chemical sensitivities or other disabilities. Such individuals want to enjoy the privileges of nonisolation, and interact with society with minimal to no allergic reactions from environmental irritants.

U.S. Pat. No. 5,645,480, issued to Spengler on Jul. 8, 1997, discloses a clean air facility providing protection against air borne particles from sources of friction. The walls are made of synthetic material, such as clear vinyl, and are welded together without the use of gaskets or joints. The flow of filtered air takes place in a five-step process. First, air flows into a HEPA filter for filtration. Then, filtered air is drawn into a blower, which sends the filtered air through air ducts. From the air ducts, the air then travels to the cells. Finally, after passing through the cells, the filtered air finally enters the room. However, the ″480 patent does not provide relief for multiple chemical sensitive, disabled or injured individuals. Synthetic materials, such as clear vinyl, may still cause allergic reactions. Also, the ″480 patent requires welding instead of connectors. Furthermore, the ″480 patent, air filtration in the present invention involves less steps. Moreover, although the ″480 patent discloses no particular matter will enter the room since air will be escaping form the room via a vinyl strip door, the ″480 patent does not disclose a method for a person to enter or exit the facility.

U.S. Pat. No. 5,314,377, issued to Pelosi, III on May 24, 1997, discloses a portable and collapsible clean air isolation enclosure, supported by two frame ends, joined together by a center end, and contains glove like members. Aided by a HEPA filter in a cabinet, the ″377 patent uses clear vinyl curtains to provide a sterile, pathogen, virus or dust free environment. Compared to the present invention, the ″377 patent does not serve the needs of multiple chemical sensitive, disabled or injured individuals since the ″377 patent does not disclose a base to prevent the emission of ground environmental irritants. In addition, the ″377 patent seeks to resolve the spread of communicable diseases in specific environments, such as hospitals, whereas the present invention may be used in a vast range of places and activities.

U.S. Pat. No. 4,732,592, issued to Spengler on Mar. 22, 1988, discloses a portable clean air facility formed by P.V.C. pipes, clear plastic, adhesives and a powered air blower motor with a prefilter unit on each end. Like the ″480 and ″377 patents, the ″592 patent would also not provide much relief for multiple chemical sensitive, disabled or injured individuals. Adhesives may cause allergic reactions for such individuals. Structurally, the ″592 does not disclose a base to protect such individuals from ground environmental irritants. Also, the ″592 uses P.V.C. pipes, T-joints and L-fittings for stability, whereas the present invention requires no such component for stability. In addition, the ″592 patent provides no privacy to occupants.

U.S. Pat. No. 4,693,173, issued to Saiki, et al. on Sep. 22, 1987, discloses a clean room where clean air is distributed from HEPA filters in the ceiling to and through openings in the floor, whereby such air returns to the air filters in the ceiling and discharges through the ceiling again. The ″173 patent is useless for multiple chemical sensitive, disabled or injured individuals. Although such patent provides a dust free environment, such patent does not dispel other environmental irritants. In addition, unlike the present invention, the ″173 patent recycles the air in an enclosed arrangement. Moreover, such patent is neither lightweight, easy to assemble, nor portable.

### SUMMARY OF INVENTION

The present invention comprises a plurality of sides, a base, and a top, which form a booth, and an air filter system. Each component must be free of known environmental irritants, and must not cause any irritations or allegeric reactions. The invention may be relatively lightweight, portable, sturdy, easy to assemble and placed in a vast range of locations. Furthermore, the invention may provide privacy. The principal object of the present invention is to form a protective unit providing an opportunity for active participation in life activities for individuals having sensitivities to chemicals in the general environment or related disabilities. The booth provides accessibility to areas once considered wholly inaccessible to such people.

A further object of the invention is to protect individuals having chemical sensitivities or related disabilities when engaged in various activities. To that end, the present invention is a shelter relatively free from environmental chemical irritants within a larger area where activities are to be performed. The present invention employs materials that minimize release and retention of environmental chemical irritants and an air filter system designed to support breathing and to minimize exposure to such irritants.

The booth is constructed primarily from materials that minimize release and retention of environmental and chemical irritants, and are designed to protect against exposure to such irritants. The air filter system filters an ambient air supply adequate to support the size and number of occupants of the booth, and the airflow exchange rate and air pressure are maintained to support breathing and to minimize the environmental irritants that enter the booth. The booth may be employed in many activities, including but not limited to attending work, school, meetings, movies, plays, concerts, ball games, political rallies, and engaging in other public activities and events.

### BRIEF DESCRIPTION OF DRAWINGS

The nature and characteristic features of the invention will be more readily understood from the following description taken in connection with the accompanying drawings forming part hereof in which:

FIG. 1 is a complete front view of the invention.

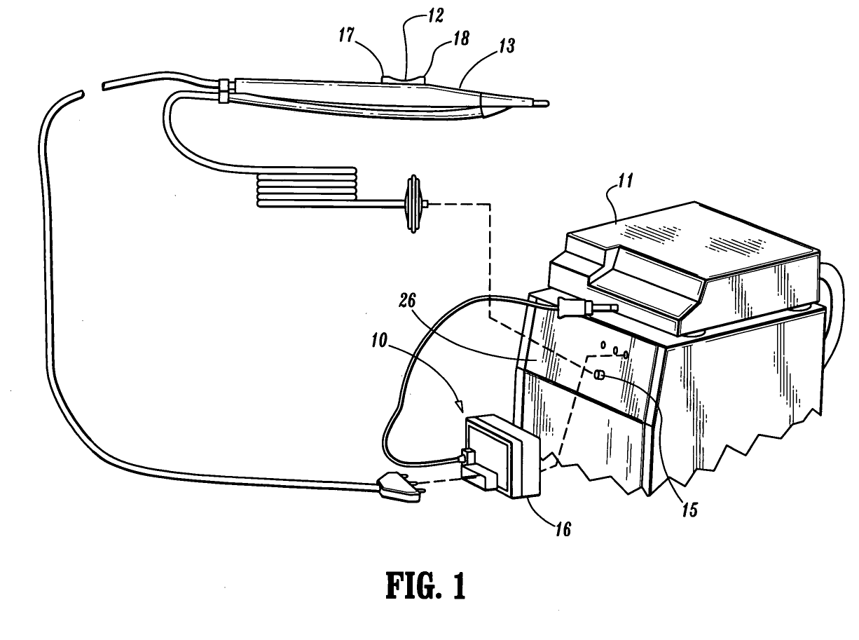

FIG. 2 is a view of the invention with its door open.

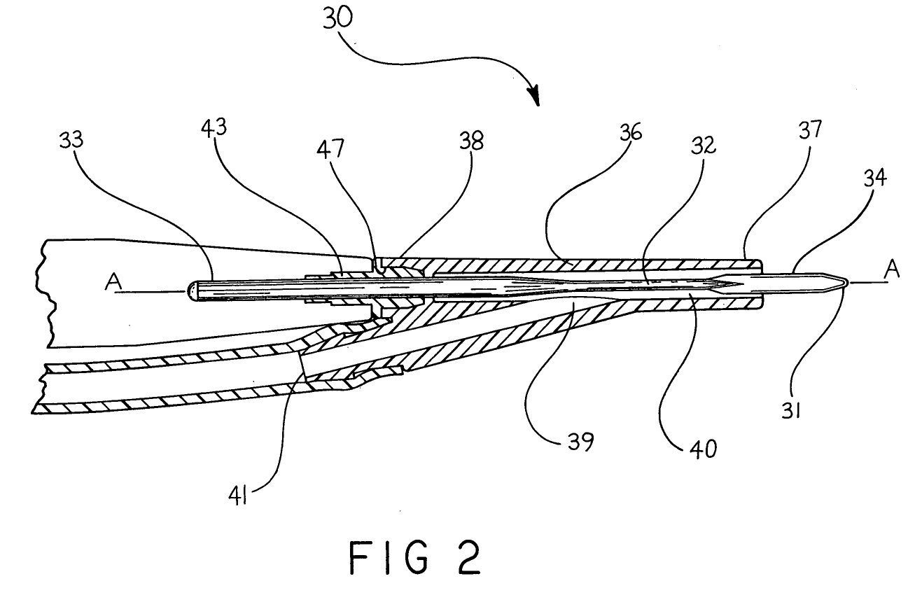

FIG. 3 is an exaggerated bottom view, in partial section, of the base with risers.

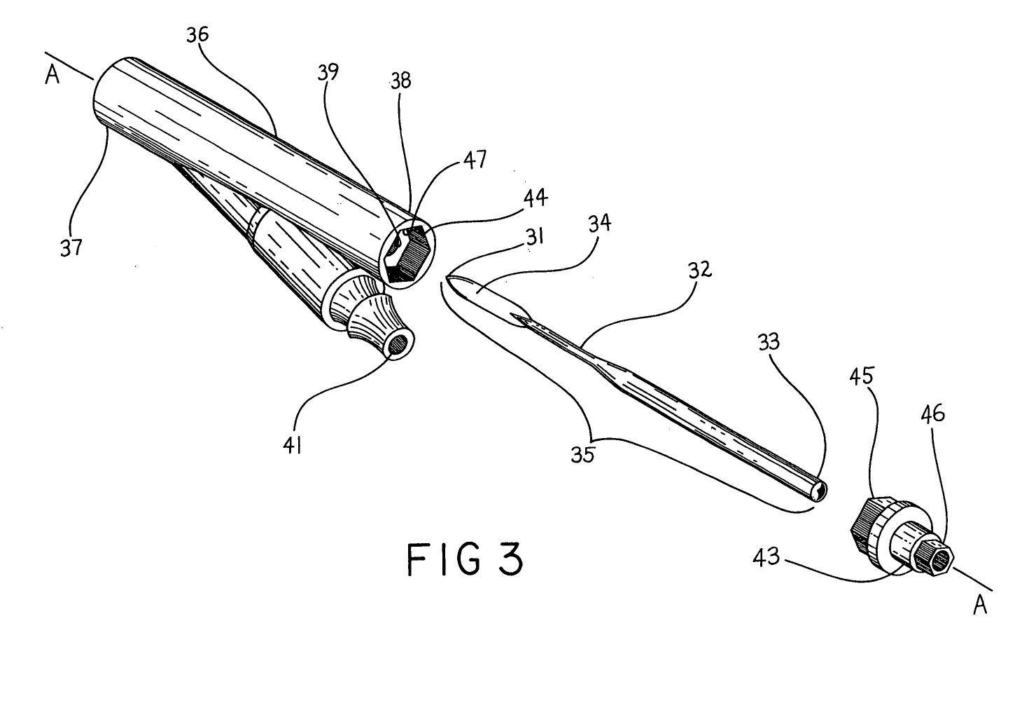

FIG. 4 is a front view of the plexiglass side of the invention illustrating the holes in the plexiglass.

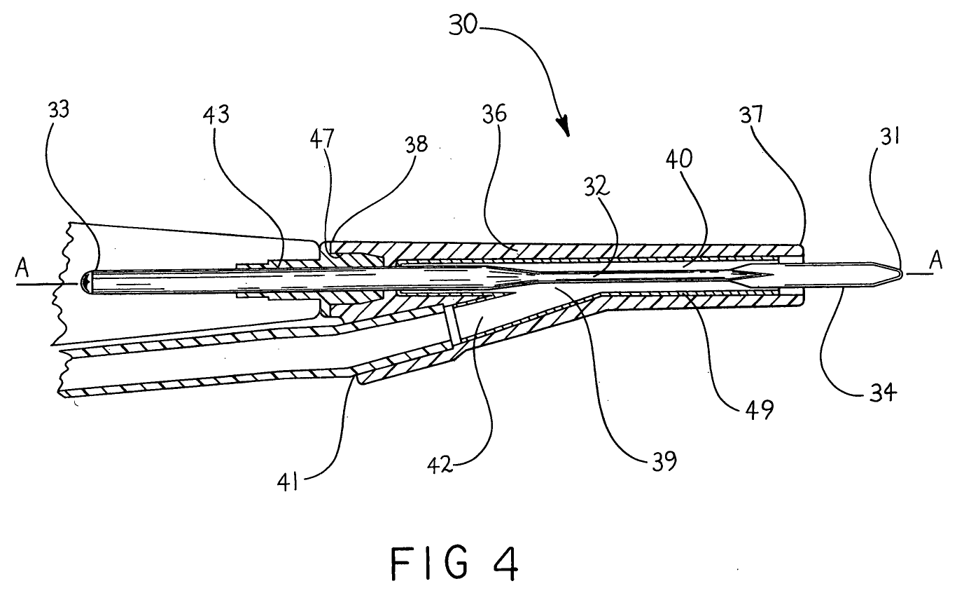

It should, of course, be understood that the description and drawings herein are merely illustrative, and that various modifications and changes can be made in the structure disclosed without departing from the spirit of the invention.

### DETAILED DESCRIPTION

The present invention is directed to preventing exposures for individuals with multiple chemical sensitivity. The invention aids accessibility to places of public accommodation. Such places are often considered impossible for them because of toxins, chemicals, and other environmental irritants. The invention provides a fresh air supply, free of contaminants to people suffering from chemical sensitivity.

In one embodiment, the invention is made with non-irritating emitting materials: base 36, a top 24, a plurality of sides 22, 28, 54, and 70, an air filter system (not shown), and sound system 40. Other materials that do not emit environmental irritants may also be used.

The booth is stabilized without environmentally harmful adhesives that may cause adverse physical reactions to those with multiple chemical sensitivities, such as seals and clasps 32. The materials are non-toxic so that the occupant of the booth is not exposed to toxins that may cause illness, disability or even death.

The booth is comprised of a plurality of sides, such as sides 22, 28, 54 and 70. Any one side, such as side 54, may be partially comprised of transparent material, such as plexiglass, to allow the occupant to see outside of the booth. Transparent material may also make the booth inconspicuous so it will blend into the environment so as not to attract attention.

The sides fit snugly together through the use of fasteners, such as wingnuts and bolts 32. The plexiglass fits snugly into slots (not shown) cut into the wooden frame of the booth. The sides of the booth may be stabilized with connectors and fasteners 32, such as wingnuts and bolts, to keep sides together to minimize air penetration.

Sides 27 and 28 may be comprised of a solid, nontransparent material, such as pinewood 27 and 28. The pinewood 28 may be used on the side paneling from the bottom to the midway point of the side of the booth. Any side of the booth, such as sides 27 and 28, may consist of opaque materials, such as wood, that have been used to separate the occupant of the booth from environmental irritants, and to provide privacy to the occupant.

Door 54 may provide an entrance/exit into and out of the booth. Door 54 may be connected to wooden frame 30 of the booth by piano hinge 62. Magnet 58 used on the door and magnet 60 inside the frame of the booth may be used to keep door 54 closed. Door 54 may be comprised of a transparent material, such as plexiglass. Door 54 may be comprised of transparent materials but could be any material separating the occupant from outside environmental or chemical irritants.

Optional wheelchair ramp 38 may be located directly behind the door. Wheelchair ramp 38 may consist of a solid material, such as wood, capable of withstanding the weight of a wheelchair. Because some individuals with multiple chemical sensitivities are wheelchair bound, wheelchair ramp 38 may allow more people to use the booth, and provide better entrance/exit into the booth.

Base 36 is used to minimize air penetration, is constructed of non-emitting materials, such as masonite, and may provide a means for further stabilization. Base 36 fits inside the bottom of the booth. Base 36 is cut to the dimensions of the frame inside of the booth. Base 36 fits snugly inside the frame of the booth without using adhesives that might emit environmental irritants. Base 36 may be made so as to withstand the weight a person in a chair or wheelchair. Base 36 may also include risers 64 made of a solid material, such as wood, so the base is even with the frame of the booth.

Top 24 fits snugly over the sides without using adhesives that might emit environmental irritants. Top 24 of the booth may be used to minimize air penetration into the booth and may be constructed of non-emitting material.

Chairs and wheelchairs composed of inert materials may be placed within the booth to provide seats for occupants utilizing the booth.

The booth may include a wireless sound system 40, such as an infrared sound system (for example, StarSound™ sound system), or placement of a microphone on the outside of the booth which would feed into the speakers inside the booth. Holes 68 in the plexiglass of the booth may also serve as a method to provide sound into the booth.

The booth includes an air filter system (not shown). The air filter system allows air to be pumped into the booth. The air filter system is connected to air duct 52 that sits on top of the booth and is connected into the booth. Fasteners to the top stabilize air duct 52. The air filter system allows air to exit through tiny gaps 48 (i.e. the air pressure in the booth will be greater than that outside the booth), thus preventing any toxins from entering at these junctions. The air filter includes a power source 54; an air inlet 56 and outlet 48; and provides a sufficient airflow exchange rate to prevent exposure from environmental toxins. The air pressure may be greater inside rather than outside the present invention.

The air filter system (not shown) is comprised of an air pump and filter, such as a HEPA or ULPA filter, rather than electrostatic filters, nylon filters, and carbon activated filters which may either out gas or produce ozone, both of which degenerate the health of occupants inside the booth. The filter must be efficient enough to separate the dust, aromatics, and other toxins from the air.

The air filter is inside box 50. The box may be composed of a solid, opaque material that is capable of insulating the sound from the filter system. The box may include such sound proofing material, such as foam, to minimize the noise of the air filter system.

There may be a suspension wire 46 that supports top 24 that supports the air filter system of the present invention. Suspension wire 46 may prevent the air filter system from collapsing into the booth.

Portability is critical to the present invention. Because the sides of the present invention are kept together through the use of wingnuts and bolts rather than adhesives or resins, the present invention is easy to assemble and disassemble. The present invention is assembled and disassembled in less five minutes. When the present invention is disassembled the sides are laid flat, providing for easy storage.

I claim:

1. An apparatus for isolating a user from an environment, comprising:
a base;
a plurality of sides, in communication with said base;
a top; and
an air filtration system;
wherein said base, said plurality of sides, said top, and said air filtration system communicate with seals and clasps which are non-irritating to the user with multiple chemical sensitivities.

2. The apparatus of claim 1, wherein said plurality of sides incorporates a transparent material.
